(19) United States
(12) Patent Application Publication
(10) Pub. No.: US 2014/0063776 A1
(43) Pub. Date: Mar. 6, 2014

(54) LED lighting system

(71) Applicants: Walter Blue Clark, Palo Alto, CA (US); Jeffry Mellor, Union City, CA (US); Abir Abi Abboud, San Jose, CA (US); Hiep Phan, San Jose, CA (US)

(72) Inventors: Walter Blue Clark, Palo Alto, CA (US); Jeffry Mellor, Union City, CA (US); Abir Abi Abboud, San Jose, CA (US); Hiep Phan, San Jose, CA (US)

(73) Assignee: FINELITE INC., Union City, CA (US)

(21) Appl. No.: 13/987,792

(22) Filed: Sep. 3, 2013

Related U.S. Application Data
(60) Provisional application No. 61/743,310, filed on Sep. 4, 2012.

(51) Int. Cl. F21S 8/06

(52) U.S. Cl. CPC F21S 8/061
USPC 362/20; 362/370

(57) ABSTRACT

A lighting system includes a low-profile LED driver box with quick connect LED drivers that are accessible through service doors, panels or plates. The LED driver box attaches to a ceiling mount to support or suspend an LED light fixture. The LED light fixture is suspended from the LED driver box through a power-feed suspension mechanism that includes at least one direct current power conductor cable to power to the LED light fixture. The LED light fixture includes one or more linear arrays of LEDs. The system also includes a controller or dimming circuit for controlling light output and/or a backup battery for providing power to the LED light fixture in the event of a power failure.

### RELATED APPLICATION

This application claims priority under 35 U.S.C. §119(e) from the co-pending U.S. provisional patent application Ser. No. 61/743,310, filed on Sep. 4, 2012, and titled “LED DRIVER JUNCTION BOX FOR LED LIGHT FIXTURES.” The provisional patent application Ser. No. 61/743,310, filed on Sep. 4, 2012, and titled “LED DRIVER JUNCTION BOX FOR LED LIGHT FIXTURES ” is hereby incorporated by reference.

### FIELD OF THE INVENTION

This invention relates to lighting systems. More specifically, this invention relates to Light Emitting Diode (LED) devices and systems.

### BACKGROUND OF THE INVENTION

A light-emitting diode (LED) is a semiconductor diode that emits light when an electrical current is applied in the forward direction of the device, such as in a simple LED circuit.

The device is fabricated from layers of silicon and seeded with atoms of phosphorus, germanium, arsenic or other rare-earth elements. The layers of the device are called the die and the junction between the materials is where the light is generated. The electricity enters from one side of the die and exits out the other. As the current passes through the LED device, the materials that makes up the junction react and light is emitted.

LEDs are widely used as indicator lights on electronic devices and increasingly in higher power applications such as flashlights and area lighting. A LED is usually a small area (less than 1 mm²) light source, often with optics added to the chip to shape its radiation pattern and assist in reflection. The color of the emitted light depends on the composition and condition of the semiconducting material used, and can be infrared, visible, or ultraviolet.

### SUMMARY OF THE INVENTION

The present invention is directed to a LED lighting system. The system includes a recessed or a low-profile LED driver box. The LED driver box houses one or more LED drivers or driver circuits that power one or more LED light fixtures. In accordance with the embodiments of the invention, the LED drivers are vertically stacked LED or horizontally stacked LED driver within the LED driver box. The LED drivers individually or collectively provides 40 watts of power or more. The LED driver box includes one or more service plates or service doors to access and/or service the LED drivers and any electrical connections therein.

Preferably, the LED drivers are coupled to a load circuit and one or more light fixture through quick-lock or snap connectors, such that the LED drivers can be readily replaced without rewiring. In further embodiments of the invention, a battery provides back-up power to an LED light fixture couple to the LED driver box in the event of a power failure.

The system of the present invention also includes a mechanism to attach and secure the driver box to one or more T-bar supports of a suspended ceiling and/or one or more ceiling joists. For example, the system includes one or more expandable horizontal support bars that attach to the T-bar supports or the ceiling joists. The LED driver box can also include a ventricle support bracket for attaching to a building structure to provide additional vertical support for the LED driver box and an LED light fixture attached to the LED driver box.

In accordance with the embodiments of the invention, the LED driver box is configured to suspend one or more LED light fixtures through one or more suspension cables. The system is preferably adaptable for having one to four suspension cables for each LED driver box. Preferably, at least one of the suspension cables is also a power feed for powering an LED light fixture, referred to herein as a power-feed suspension mechanism. In accordance with the embodiments of the invention a power-feed suspension mechanism includes cables with at least one cable having direct current positive conductor and at least one cable having a direct current negative conductor.

In accordance with further embodiments of the invention an LED light fixture, that is coupled to and suspended from the LED driver box is formed from modular lighting units or lighting elements. A lighting element includes a housing, one or more diffusion lenses and a linear array of LEDs. The linear arrays of LEDs include, for example 20 or more light emitting diodes that each use 0.2 watts or less of electrical power. The system can also include a controller or dimming circuit to provide dimming control of light emitted from the linear arrays of LEDs. Where the LED light fixture provides both upward lighting and downward light, the controller or dimming circuit is configured to provide independent control of the upward lighting and downward light emitted from the linear arrays of LEDs.

The lighting elements of the present invention are used to make light fixtures having any number of geometric shapes including, but not limited to square, rectangular, triangular, pentagonal and hexagonal shapes, to name a few. As described above, the lighting elements are configured to provide, upward light, downward light or any combination thereof Addition feature of LED light fixtures formed from the lighting elements are described in U.S. Pat. No. 13/507,542, filed Jul. 9, 2012 and titled “LIGHT EMITTING DIODE LUMINAIRE DEVICE AND SYSTEM” and the Provisional Patent Application No. 61/796,717, filed Nov. 19, 2012 and titled “LED LUMINAIRE DEVICE AND SYSTEM,” the contents of which are both hereby incorporated by reference.

### BRIEF DESCRIPTION OF THE DRAWINGS

FIG. 1A is a schematic representation of an LED lighting system, in accordance with the embodiments of the invention.

FIG. 1B shows a cross-sectional view of a recessed LED driver box with two LED drivers, in accordance with the embodiments of the invention.

FIG. 2 shows a perspective view of a recessed LED driver box coupled to T-bar of a suspension ceiling through an expandable horizontal support bar, in accordance with the embodiments of the invention.

FIG. 3 shows a perspective view of a recessed LED driver box with a bottom access door for replacing or fixing an LED driver therein, in accordance with the embodiments of the invention.

FIG. 4 shows a lighting system with an LED light fixture suspended from a recessed LED driver box, in accordance with the embodiments of the invention.

FIG. 5 shows a lighting system with a light fixture formed from modular lighting elements and being suspended from recessed LED driver box, in accordance with the embodiments of the invention.

FIG. 6 shows a schematic representation of a low-profile recessed LED driver box, in accordance with the embodiments of the invention.

FIG. 7 shows and exploded view of a lighting system with a low-profile recessed LED driver box and a light fixture formed from modular lighting elements, in accordance with the embodiments of the invention.

### DETAILED DESCRIPTION OF THE INVENTION

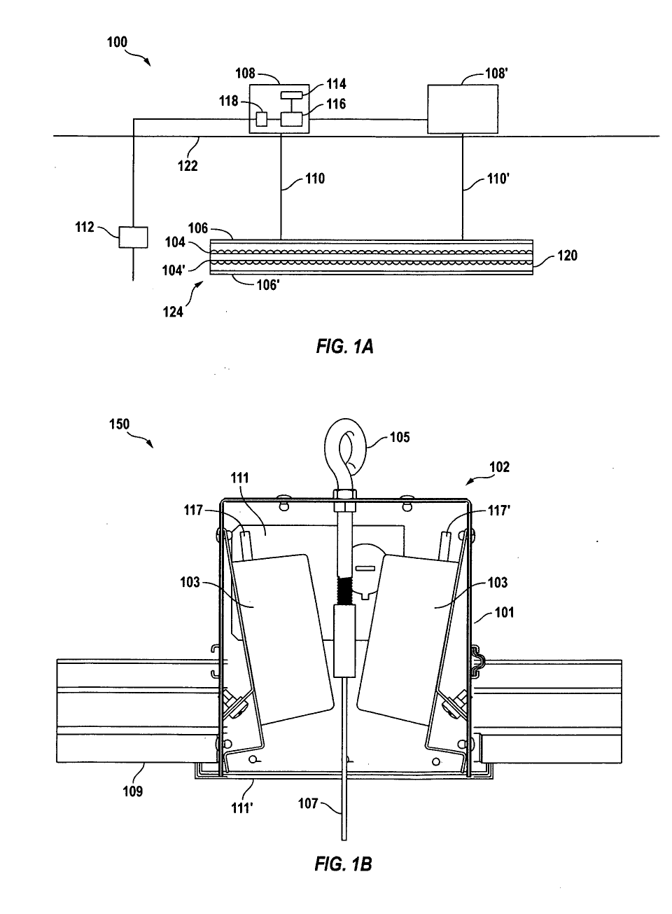

FIG. 1A is a schematic representation of an LED lighting system 100, in accordance with the embodiments of the invention. The lighting system 100 of the present invention includes recessed or a low-profile LED driver boxes 108 and 108′ that couple to portions of a ceiling 122. At least one of the LED driver boxes 108 houses one or more LED drivers or driver circuits 116 that power one or more LED light fixtures 124.

The LED light fixture 124 includes a housing 120, one or more diffusion lenses 106 and 106′ and linear arrays of LEDs 104 and 104′. The linear arrays of LEDs 104 and 104′ include, for example 20 or more light emitting diodes that each use 0.2 watts or less of electrical power. The system 100 can also include a controller or dimming circuit 118 to provide dimming control of light emitted from the linear arrays of LEDs 104 and 104′. Where the and linear arrays of LEDs 104 and 104′ provides both upward lighting and downward light, the controller or dimming circuit 118 is configured to provide independent control of the upward lighting and downward lighting emitted from the linear arrays of LEDs 104 and 104′.

The control controller or dimming circuit 118 and the LED driver or driver circuit 116 are electrically coupled to a load circuit 112 for providing direct current power to the LED light fixture 124 through the LED driver or driver circuit 116. In accordance with the embodiments of the invention, the system 100 includes a power-feed suspension mechanism 110 and 110′ for suspending the LED light fixture 124 from the LED driver boxes 108 and 108′. In this embodiment the suspension cable 110 is also a direct current positive conductor that feeds from one end of the LED light fixture to route direct current to a direct current negative conductor 110′ through the plenum at an opposite end of the LED light fixture 124. The system 100 can also include a back-up battery 114, either within the LED driver box 108 or outside of the LED driver box 108. The back-up battery 114 is coupled to the power-feed suspension mechanism 110 and 110′ for providing power to the LED light fixture 124 in the event of a power failure.

FIG. 1B shows a cross-sectional view 150 of an LED driver box 102 with a housing 101 for housing two LED drivers 103 and 103′. In accordance with the embodiments of the invention, the LED drivers 103 and 103′ are vertically stacked or horizontally stacked within the LED driver box 102. The LED drivers 103 and 103′ individually or collectively provide 40 watts, or more, of power. The LED driver box 102 includes one or more service doors 111 and 111′ or service plates 111 and 111′ to access and/or service the LED drivers 103 and 103′ any electrical connections therein. Preferably, the LED drivers 103 and 103′ are coupled to a load circuit and one or more light through quick-lock or snap connectors 117 and 117′. Accordingly, the LED drivers 103 and 103′ can be readily replaced when a power failure occurs without requiring rewiring of the lighting system 100 (FIG. 1).

The LED driver box 102 of the present invention also includes a ventricle support bracket 105 for attaching to a building structure to provide additional vertical support for the LED driver box 102 with an LED light fixture attached to the LED driver box 101 through, for example a suspension cable 107. The LED driver box 102 can also include mechanism to attach and secure the LED driver box to one or more T-bar supports 109 of a suspended ceiling and or one or more ceiling joists.

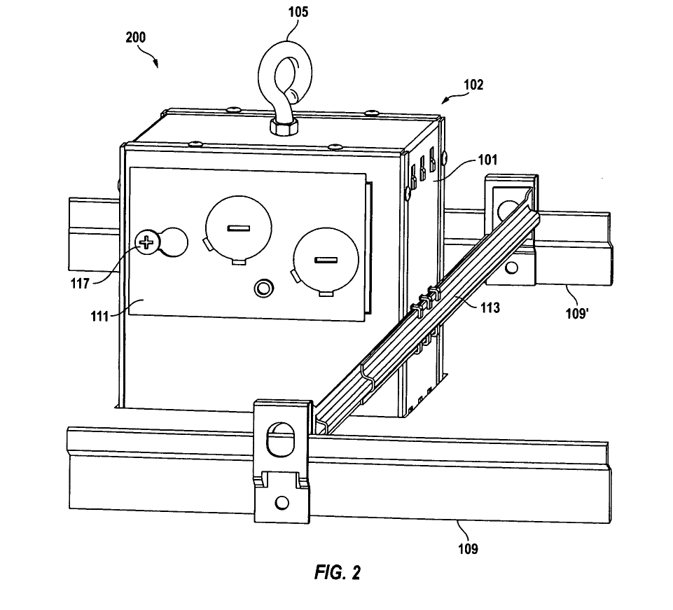

FIG. 2 shows a perspective view 200 of the LED driver box 102 coupled to T-bars 109 and 109′ of a suspension ceiling through an expandable horizontal support bar 113, in accordance with the embodiments of the invention. As above, the LED driver box 102 includes a housing 101 for housing two LED drivers 103 and 103′ (FIG. 1B) and can also have a ventricle support bracket 105 for providing additional vertical support for the LED driver box 102 with an LED light fixture attached thereto. The LED driver box 102 has a service door or service plate 111 that can be opened by removing, for example, a screw feature 117. The service door or service plate 111 also proves a port for attaching conduit and wiring to the two LED drivers 103 and 103′ from a load circuit.

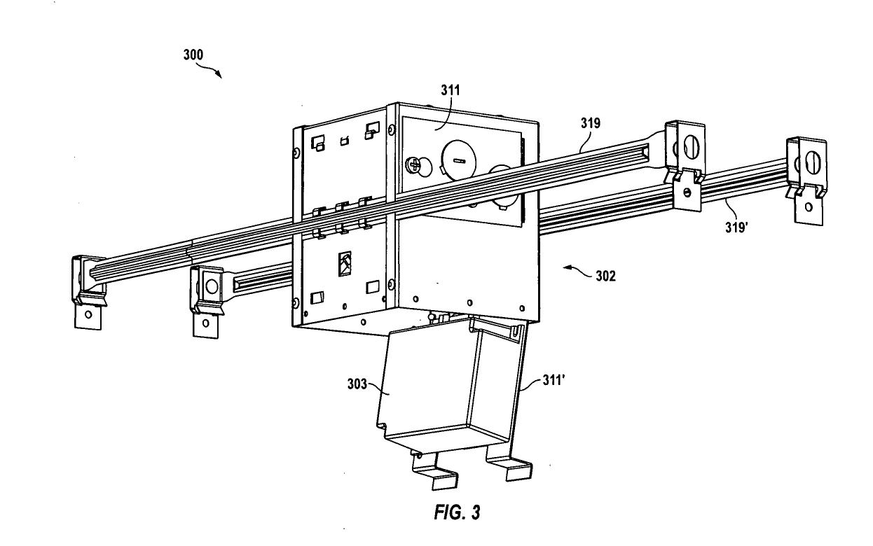

FIG. 3 shows a perspective view 300 of a LED driver box 302 with a hinged bottom service door 311′ for replacing or fixing an LED driver 303 therein, in accordance with the embodiments of the invention. The LED driver box 302 also includes a removable service plate 311 and is configured to couple to expandable horizontal support bars 319 and 319′ for attaching to T-bar supports or ceiling joists, such as described previously.

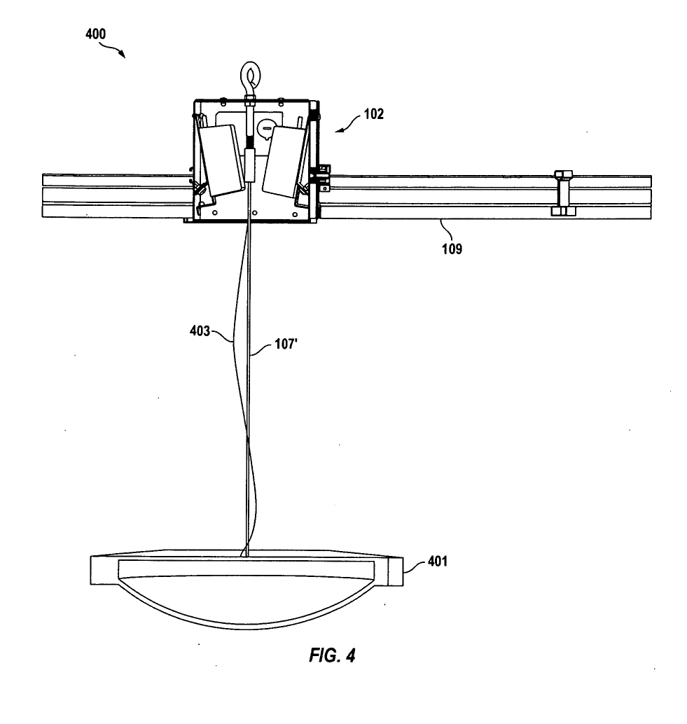

FIG. 4 shows a lighting system 400 with an LED light fixture 401 that is suspended from the LED driver box 102 of the present invention. The LED driver box 102 is attached to, for example, a T-bar 109 of a suspension ceiling. The LED light fixture is suspended through a suspension cable 107′ and is powered by one or more of the LED drivers housed within the LED driver box 102 through a power feed 403.

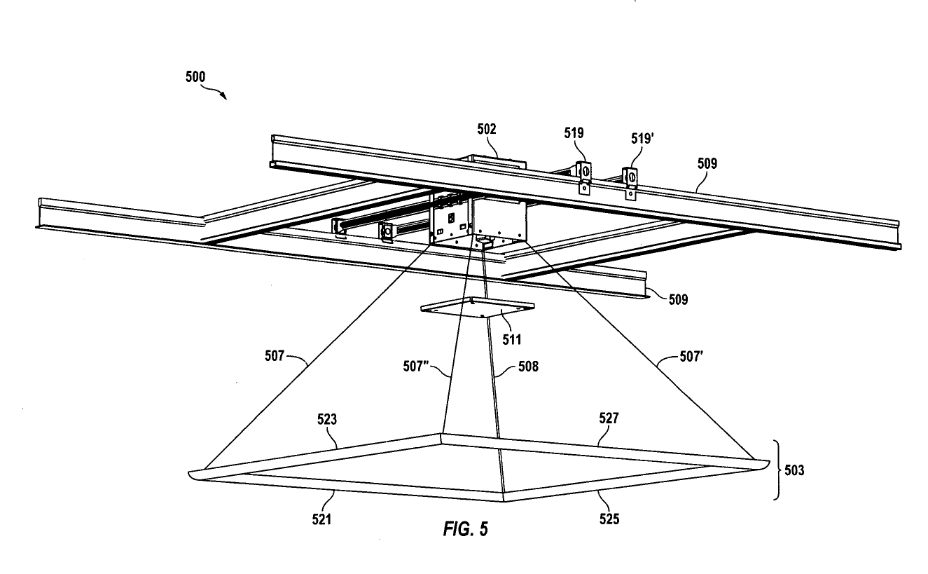

FIG. 5 shows a lighting system 500 with an LED light fixture 503 that is formed from modular lighting elements 521, 523, 525 and 527. In accordance with a preferred embodiment of the invention, the LED light fixture 503 is suspended from an LED driver box 502 by a power-feed suspension mechanism comprising any number of suspension cables 507, 507′, 507″ and 508. The power-feed suspension mechanism includes at least one suspension cable 508 that provides a direct current positive conductor and a direct current negative conductor for providing power to the LED light fixture 503. Alternatively, any of the other suspension cables 507, 507′, 507″ can have a direct current positive conductor and/or direct current negative conductor for providing power to the LED light fixture 503. While the power-feed suspension mechanism is shown here with four suspension cables, the lighting system 500 of the present invention is preferably adaptable to have a power-feed suspension mechanism with one to four suspension cables.

As described above, the LED driver box 502 includes one or more LED drivers or driver circuits for powering the LED light fixture 503 through the power-feed suspension mechanism. The LED driver box 502 has one or more service doors or service plates 511 to access and/or service the LED drivers and any electrical connections contained within the LED driver box 502. The LED driver box 502 is configured to couple to expandable horizontal support bars 519 and 519′ for attaching to T-bar supports 509 and 509′ or ceiling joists, such as described previously.

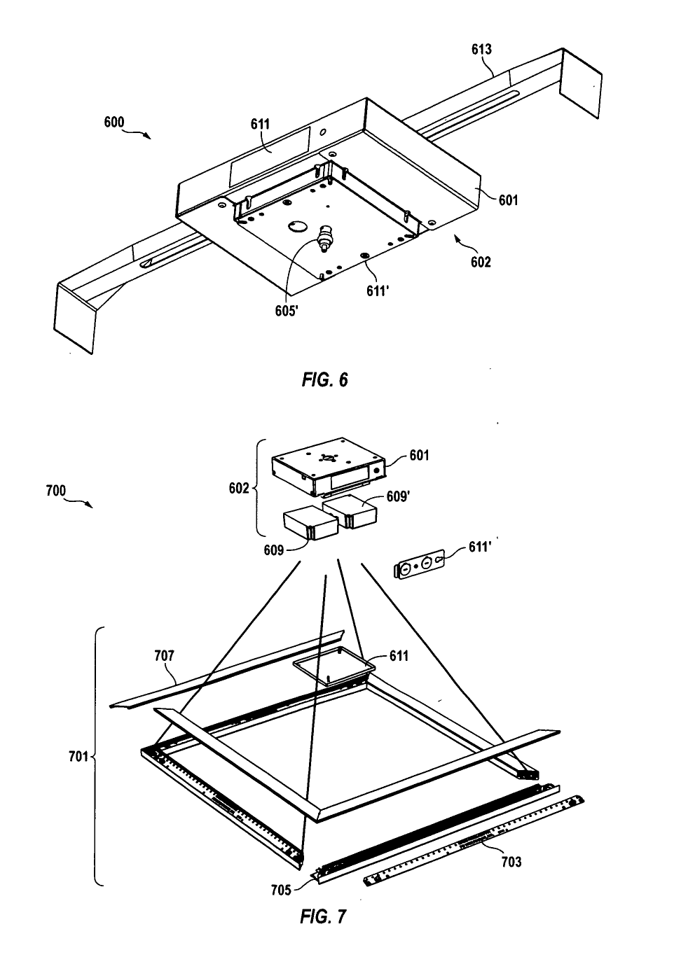

FIG. 6 shows a schematic representation of a low-profile LED driver box 602, in accordance with the embodiments of the invention. The low-profile LED driver box 602 is particularly well suit for installing LED lighting systems where there is very little clearance between a ceiling and other building structures. The low-profile LED driver box 602 includes a housing for housing two ore more LED drivers or driver circuits 609 and 609′ (FIG. 7) is configured to couple to an expandable horizontal support bar 613 that include a support stud 605′ that passed through the low-profile LED driver box 602. The expandable horizontal support bar 613 is used to attach the low-profile LED driver box 602 to T-bar supports or ceiling joists. The low-profile LED driver includes one or more service doors 611′ or service plates 611 that can be opened to service the low-profile LED driver box 602. The service plate 611 also proves a port for attaching conduit and wiring to the low-profile LED driver box 602 from a load circuit.

FIG. 7 shows and exploded view 700 of a lighting system with a low-profile LED driver box 602 and an LED light fixture 701 that is formed from modular lighting elements, in accordance with the embodiments of the invention. The low-profile LED driver box 602 includes a housing 601 and the two or more LED drivers or driver circuits 609 and 609′. The low-profile LED driver box 602 also includes a service plate 611′ and a bottom service door 611′ (FIG. 6), as described above. The low-profile LED driver box 602 also preferably includes a canopy plate 611 that covers the bottom service door 611′ an engages suspension cables of a power-feed suspension mechanism. The LED light fixture 701 is formed from lighting elements that include a top portion 707 with a top diffuser lense, a bottom portion 705 with a bottom diffuser lense and one or more linear arrays of LEDs 703.

The present invention provides a number of advantages overt prior art LED lighting systems. The recessed or low-profile driver box is de-coupled or separate from any LED light fixture that it provides power for. This allows for easy servicing of the LED drivers and the wiring within the LED driver box through service doors, panels or plates. Also, the LED light fixture is easy to service since the LED light fixture has minimal wiring and the linear arrays of LEDs within the light fixture can be replaced when they fail. The position of the LED light fixture and the height of the LED light fixture is easily adjusted through suspension cables coupled to the LED driver box. The LED driver box is readily adapted for one, two, three, four or more suspension cable configurations for supporting a variety of different LED light fixtures and/or for providing power to LED light fixtures through an integrated power-feed suspension mechanism.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A lighting system comprising a LED driver box comprising:
a) a housing with one or more service doors or access plates; and
b) a brace or bracket for attaching the housing to a portion of a ceiling structure;
c) one or more LED driver circuits accessible through the one or more access doors;
d) a suspension mechanism for suspending and the LED light fixture from the LED driver box; and
e) a power feed for powering and LED light fixture.

2. The lighting system of claim 1, wherein the one or more LED driver circuits are coupled to a load circuit through quick-lock or snap connectors.

3. The lighting system of claim 1, wherein the suspension mechanism includes at least one suspension cable and wherein the at least one suspension cable is the power feed for powering and LED light fixture.

4. The lighting system of claim 3, wherein the suspension mechanism is adaptable for having one to four suspension cables.

5. The lighting system of claim 1, further comprising a back-up battery coupled to the power feed for providing power to the LED light fixture in the event of a power failure.

6. The lighting system of claim 1, further comprising a controller coupled to the one or more LED driver circuits for controlling light emitted by the LED light fixture.

7. A lighting system comprising;
a) a low-profile LED driver box with one or more LED driver circuits that are accessible through one or more service doors and means for attaching the low-profile LED driver box to a portion of a ceiling;
b) an LED lighting fixture comprising one or more modular linear arrays of LEDs; and
c) a power-feed suspension mechanism for suspending LED light fixture from the low-profile LED driver box and for powering and the LED light fixture.

8. The lighting system of claim 7, wherein the one or more LED driver circuits connect to a load circuit and to the LED lighting fixture through quick-lock or snap connectors.

9. The lighting system of claim 7, further comprising a back-up battery coupled to the power-feed suspension mechanism for powering the LED light fixture in the event of a power failure.

10. The lighting system of claim 7, wherein the power-feed suspension mechanism comprises cables with at least one cable having direct current positive conductor and at least one cable having a direct current negative conductor.

11. The lighting system of claim 7, further comprising a back-up battery coupled to the power-feed suspension mechanism for powering the LED light fixture in the event of a power failure.

12. The lighting system of claim 7, further comprising a controller coupled to the one or more LED driver circuits for controlling light emitted by the LED light fixture.

13. A lighting system comprising:
a) a low-profile LED driver box with two LED driver circuits that are accessible through a service door and for providing at least 40 Watts of power and one or more expandable support brackets for attaching to a portion of a ceiling;
b) an LED light fixture comprising one or more lighting elements with linear arrays of LEDs for providing both upward lighting and downward lighting;
c) a power-feed suspension mechanism for suspending the LED light fixture from the low-profile LED driver box comprising suspension cables with at least one cable having a direct current positive conductor and at least one cable having a direct current negative conductor; and
d) a controller for proving independent dimming control of the upward lighting and downward lighting emitted from the linear arrays of LEDs.

14. The lighting system of claim 13, wherein linear arrays of LEDs include 20 or more light emitting diodes.

15. The lighting system of claim 13, wherein the 20 or more light emitting diodes each use 0.2 watts or less of electrical power.

16. The lighting system of claim 13, wherein the power feed suspension mechanism for suspending the LED light fixture comprises two to four cables.

17. The lighting system of claim 13, wherein the service opens from a bottom portion of the low-profile LED driver box.

18. The lighting system of claim 17, further comprising a canopy plate that couples to the service door of the low-profile LED driver box.

19. The lighting system of claim 13, wherein the two LED driver circuits are coupled a load circuit and the power-feed suspension mechanism through quick-lock or snap connectors.

20. The lighting system of claim 13, further comprising a back-up battery coupled to the power-feed suspension mechanism for powering the LED light fixture in the event of a power failure.
